(19) United States
(12) Patent Application Publication
(10) Pub. No.: US 2005/0196503 A1
(43) Pub. Date: Sep. 8, 2005

(54) High-intensity sweetener-polyol compositions

(76) Inventor: Sunil Srivastava, Oak Brook, IL (US)

Correspondence Address: WALLENSTEIN WAGNER & ROCKEY, LTD, 311 SOUTH WACKER DRIVE, 53RD FLOOR, CHICAGO, IL, 60606, US

(21) Appl. No.: 11/073,025

(22) Filed: Mar. 4, 2005

Related U.S. Application Data
(60) Provisional application No. 60/550,377, filed on Mar. 5, 2004.

(51) Int. Cl. A23G 3/30

(52) U.S. Cl. 426/548

(57) ABSTRACT

The present invention provides a sweetener composition and methods for improving the taste of a sweetener composition. The sweetener composition includes a mixture of a high-intensity sweetener such as aspartame, encaspsulated aspartame, neotame, encapsulated neotame, cyclamate, sucralose, saccharin or Acesulfame-K, with polyols such as maltitol, sorbitol, mannitol, erythritol, xylitol, lactitol, or palatinit, wherein the high-intensity sweetener is present in the mixture in an amount from about 0.0001% to 15% by weight.

### CROSS-REFERENCE TO RELATED APPLICATIONS

This application claims priority from U.S. Provisional Application No. 60/550,377, filed Mar. 5, 2004.

### FEDERALLY SPONSORED RESEARCH OR DEVELOPMENT

Not applicable.

### TECHNICAL FIELD

The present invention relates to a sweetener composition and a method for improving the taste of a sweetener, which includes a high-intensity sweetener and a polyol. The sweetener composition positively affects the taste, quick onset, or linger. Additionally, the sweetener composition provides good mouth-feel and masks potentially unpleasant characteristics. These blends allow the use of lower quantitative amounts, while resembling the same characteristics of sugar.

### BACKGROUND OF THE INVENTION

Polyols are sugar-free sweeteners. Polyols are carbohydrates, but they are not sugars. Polyols are derived from carbohydrates whose carbonyl group (aldehyde or ketone, reducing sugar) has been reduced to a primary or secondary hydroxyl group. The most widely used polyols are sorbitol, mannitol, and maltitol. Sorbitol is derived from glucose, mannitol from fructose, and maltitol from high maltose corn syrup. Although polyols are derived from sugars, they are not processed by the body like sugars. Chemically, polyols are considered polyhydric alcohols or sugar alcohols because part of their structure resembles sugar and part resembles alcohols. However, these sugar-free sweeteners are neither sugars nor alcohols, as these words are commonly used. Unlike high-potency sweeteners like aspartame, encapsulated aspartame, neotame, encapsulated neotame, cyclamate, sucralose, saccharin and Acesulfame K which are used in very small amount, polyols are typically used in the same quantity as sucrose.

In contrast to sugar, polyols have many advantages such as reduced calories as compared to sugar, reduced insulin response, the ability to be labeled “sugar-free” and “no sugar added.” They do not promote tooth decay, and they do not brown in bakery applications (i.e. no Maillard reaction).

Polyols are used mostly in confectionery, food, oral care, pharmaceutical, and industrial applications. Some characteristics of polyols are fewer calories, pleasant sweetness, the ability to hold moisture, and improved processing. Polyols serve as humectants, bulking agents, and freeze-point depressants. Polyols are versatile ingredients, used in a variety of applications to provide value-adding properties. Polyols are also used in toothpaste and mouthwashes for a variety of functions such as bodying/bulking agent, crystallization inhibitor, flavoring agent/sweetener, humectant, and shelf life extenders. In cosmetics, polyols are used in lotions, moisturizers, soaps, shampoos, and other hair care products to provide conditioning, gloss, humectancy, and texture.

Polyols' industrial use aids in the production of polyurethanes, adhesives, papermaking, joint compound, tobacco, and many other applications. Their use as antistatic, chelating, and cross-linking agents, as well as a gloss enhancer, humectant, and plasticizer promote better quality for many finished products.

Perceived sweetness is subjective and depends on, or can be modified by, a number of factors. The chemical and physical composition of the medium in which the sweetener is dispersed has an impact on the taste and intensity. The concentration of the sweetener, the temperature at which the product is consumed, pH, other ingredients in the product, and the sensitivity of the taster all are important factors to consider. Sucrose is the usual standard by which the intensity of sweeteners is measured. The intensity of the sweetness of a given substance in relation to sucrose is made on a weight basis. Table 1 provides the approximate relative sweetness of many of the high-intensity sweeteners and polyols.

TABLE 1
Relative sweetness of high-intensity sweeteners and polyols.

| | Approximate sweetness |
|---|---|
| Sweeteners/Polyols | (sucrose = 1) |
| Malitol | 0.9 |
| Sorbitol | 0.6 |
| Mannitol | 0.7 |
| Erythritol | 0.7 |
| Xylitol | 1.0 |
| Lactitol | 0.4 |
| Isomalt (platinit) | 0.45-0.65 |
| Cyclamate | 30 |
| Aspartame | 180 |
| Neotame | 8,000 |
| Acesulfame-K | 200 |
| Saccharin | 300 |
| Sucralose | 600 |

Polyol and high-intensity sweetener blends have been used as synergetic mixtures [Schiffinan, S. S. et al. Chem. Senses, 25,131(2000); Schiffman, S. S. et al. Brain Res. Bull. 38, 105 (1995)], but have not been used to improve the taste quality (quick onset and short or no linger or aftertaste). This invention relates to the preparation and taste improvement of polyol and high-intensity sweetener blends that have reduced calories and significant cost savings.

U.S. Pat. No. 6,368,651 describes the use of amino acids and carbohydrates including sugar, sugar alcohols and polyol, inorganic salts, inorganic weak bases, nucleotides and flavoring agents to improve the taste of the sweetener neotame. Taste modifying ingredients are disclosed in the '651 patent for neotame sweetener at a concentration which is less than the ingredient's taste threshold concentration.

In an effort to maintain sweetness over the shelf life of their product, many developers have been guilty of high-potency-sweetener overdose, often resulting in a product that is too sweet. By blending polyol and high-intensity sweeteners, the lingering effect can be minimized while the synergy/stability can be increased, resulting in a much more consistent product. These blends provide mouth-feel and mask the unpleasant characteristics of the high-intensity sweeteners. It is too simplistic to say, however, that one combination of sweeteners is ideal without considering the whole ingredient system in the product. According to Nabors, “Sweetener blends were first introduced in the 1960s in diet soft drinks, and have been extended into gelatins, puddings, flavored coffees, gum and frozen desserts.” Each of these products may have different sweetener requirements.

Blending is often done to take advantage of sweetener synergy. By combining sweeteners, the sweetness intensity is greater than the simple sum of the components, thus sweeteners are synergistic. Known synergies exist between aspartame and acesulfame-K, as noted in the Nutrinova work. Many beverages on the market are sweetened with an optimized blend of acesulfame-K and aspartame, and aspartame/saccharin has often been the stable sweetener in carbonated fountain beverages. Cyclamate displays strong synergy with a number of other sweeteners, including aspartame, saccharin and maltitol.

Several groups, such as Leatherhead Food Research Association, Surrey, England, have studied maltitol as a bulk sweetener with other more potent sweeteners. As a bulk sweetener with 90% the sweetness of sucrose, maltitol can carry much of the sweetness in a sugar-free product, and its sweetness characteristics can help to mask off certain tastes in high-potency sweeteners. Maltitol has shown strong synergy with cyclamates and acesulfame-K, and additive sweetness with aspartame. Synergy up to 20% to 30% has been shown in a 50:50 mixture of maltitol and sodium cyclamate.

Blending is frequently done to adjust temporal profiles or to mask off-tastes, but it is often the result of economic or functional considerations as well. An example of an economic or functional blend is the use of sucrose and corn syrup in hard-candy formulation. Typically, sucrose and 42 DE corn syrup are blended 50:50, 60:40, or 70:30 sucrose:corn syrup to take advantage of regional economics and to control crystallization of sucrose.

Hard candies are formed as amorphous glasses from molten polyol solutions, either HSHs or maltitol syrups, or individual polyols such as isomalt or sorbitol. In many cases, unless maltitol (90% the sweetness of sucrose) or xylitol (100% as sweet as sucrose) are in high enough concentrations, the hard candy is a glass formed from a polyol/high-potency-sweetener blend. The candy manufacturer adds the high-potency sweetener (or it can be provided to the manufacturer as a co-processed product), which the manufacturer then processes to form a hard candy, adding in its own unique flavors to the product.

Many products on the market today contain a blending of sweeteners. These sweeteners are chosen for specific reasons, whether for sweetness level or for color, flavor, glycemic effects, viscosity, texture, water activity, humectancy, binding properties, crystallizing properties, freeze-point depression, etc. Examples include sugar-free chewing gums or mints (sorbitol, mannitol, maltitol, xylitol, high-potency sweeteners), nutritional bars (polyols, fructose, corn syrups, maltodextrins, rice syrups, fruit concentrates, sucrose, glucose, maltose, high-potency sweeteners) and beverages (sucrose, corn syrups, maltodextrins, high fructose corn syrups, fructose, fruit concentrates). While one sweetener may predominate, many foods are sweetened by multiple products, whether intentional or not. By interacting more closely with ingredient suppliers, manufacturers can more efficiently use these combinations to individualize their products.

High-intensity sweeteners often have either slow onset or linger or both. It is reported that the sweetness strength or sweetening potency of the synthetic high-potency sweetener, aspartame and neotame, is about 180 and 10,000 times respectively that of sucrose in terms of weight ratio (Japanese Patent Kohyou Publication JP-A-8-503206). The compounds have a weak early taste (i.e., wherein the sweetener, when put in the mouth, tastes sweet as early as sucrose), and are strong in later taste (i.e., wherein the sweetener tastes sweet later than sucrose). Further, neotame has a strong astringent taste. Accordingly, the balance of the quality of sweetness properties for aspartame and neotame is poor when compared to sucrose. Sucrose is generally regarded as the standard for evaluating the properties or characteristics of the quality of sweetness.

Acesulfame-K is a synthetic sweetener, which is similar to aspartame (abbreviated to “APM”). Acesulfame-K has a sweetness or sweetening potency of about 200 times as high as sucrose in terms of weight ratio, but acesulfame-K is inferior to APM in terms of quality of sweetness because of acesulfame-K's strong early taste, bitter taste, astringent taste, peculiar taste and stimuli. Various improvements for acesulfame-K have been proposed, including improving its quality of sweetness by using it in combination with APM (U.S. Pat. No. 4,158,068 and its corresponding Japanese Patent Kokoku Publication JP-B-5951262 etc.). In this connection, the sweetness properties or the quality of sweetness for APM are that its early taste is weak and its later taste is strong as compared to sucrose.

Various proposals have been made for improving the quality of the sweetness of aspartame, neotame, saccharin, sucralose, cylamate and acesulfame-K, thus achieving considerable effects. This invention relates to improving the taste quality of high-intensity sweeteners by blending them with polyols where the majority of the composition (up to 95% by weight) consists of the polyol.

### SUMMARY OF THE INVENTION

Accordingly, it is an aspect of one embodiment of the present invention to positively affect or improve the taste of high-intensity sweeteners such as aspartame, encapsulated aspartame, neotame, encapsulated neotame, saccharin, sucralose, cylamate or acesulfame-K by blending them with a polyol such as maltitol, sorbitol, mannitol, erythritol, xylitol, lactitol, or palatinit.

Accordingly, one embodiment of the present invention provides a sweetener composition, which includes a mixture of a high-intensity sweetener such as aspartame, encapsulated aspartame, neotame, encapsulated neotame, saccharin, sucralose, cyclamate, acesulfame-K, or any combination thereof with a polyol such as maltitol, sorbitol, mannitol, erythritol, xylitol, lactitol, palatinit, or any combination thereof, wherein the high-intensity sweetener is present in the mixture in an amount from about 0.0001% to 15% by weight.

In another embodiment of the present invention, a method for improving the taste of a sweetener composition and positively affecting the quick onset, level of sweet linger, and aftertaste is provided. Moreover, these blends may provide synergy and will not go under Maillard browning reactions.

### DETAILED DESCRIPTION

While this invention is susceptible of embodiment in many different forms, it will herein be described in detail preferred embodiments of the invention with the understanding that the present disclosure is to be considered as an exemplification of the principles of the invention and is not intended to limit the broad aspect of the invention to the embodiment illustrated.

Preferably, the high-intensity sweetener is in the form of a powder or crystals in the mixture. Likewise, the polyol is preferably in the form of a powder or crystals in the mixture. Preferably, the mixture itself is in the form of a powder or crystals. Most preferably, the powder and/or crystals are a dry, free-flowing powder or crystals.

The crystalline form of the powdery high-intensity sweetener, such as aspartame or neotame, which is one of the active ingredients in the sweetener composition of the present invention, may consist of, but is not limited to, the known crystals (type I, IIA, IB for aspartame and monohydrate crystals of neotame either A-type crystals or C-type crystals).

In terms of the ratio of high-intensity sweetener in a high-intensity sweetener/polyol blend, the amount of high-intensity sweetener used in the sweetener composition of the present invention is preferably in the range of 0.0001% to 15% by weight, or any combination of ranges or subranges therein. More preferably, the amount of high-intensity sweetener is from about 0.005% to 5% by weight, or any combinations of ranges or subranges therein.

The sweetener composition according to the present invention is particularly suitable for use in food and drink compositions for human and animal consumption. Preferred examples consist of but are not limited to beverages, table-top sweeteners, sweetener packets, candies, ice cream, coffee, tea, cereal, liquid sweeteners, low-calorie sweeteners, gelatin desserts, bread, cookies, fruit-flavored beverages, cake mixes, fruit juices, syrups, salad dressings, pet foods, carbonated and non-carbonated soft drinks, foodstuffs, and the like.

The composition of the present invention is also suitable for other applications such as cough medicines, cough drops and tonics. The composition of the present invention may be suitably mixed with a diluent or solvent including aqueous-based, alcohol-based, mixed aqueous/alcohol-based, water, propylene glycol, a water/propylene glycol mixture, ethanol or a water/ethanol mixture. Preferably, the sweetener composition of the present invention may be used alone or will make up anywhere from about 0. 1% to greater than 99% by weight of the food or drink composition.

### EXAMPLES

Having generally described this invention, the following examples 1-14 provide a further understanding of the invention. The examples provided herein are for purposes of illustration only and are not intended to be limiting. The amounts are given as percentages by weight, except where otherwise mentioned.

The following examples are directed to evaluations of the taste-modifying polyol ingredient blended with the high-intensity sweetener in either in dry powder or water or cola-flavored beverage or powdered soft drink beverage. The amounts are given as percentages by weight, except where otherwise mentioned.

### Example 1

General Preparation of Aspartame and Polyols:

Approximately 1 gram of sweetener containing aspartame or encapsulated aspartame and polyols was prepared. Aspartame and xylitol were dry blended and the resulting mixtures had the following composition (as described in Table 2).

TABLE 2

| Aspartame (wt/wt %) | Xylitol (wt/wt %) | Sucrose equivalent |
|---|---|---|
| .55 | 99.45 | 2X |
| 1.10 | 98.90 | 3X |
| 1.66 | 98.34 | 4X |
| 2.22 | 97.78 | 5X |
| 2.77 | 97.23 | 6X |
| 3.33 | 96.67 | 7X |
| 3.88 | 96.12 | 8X |
| 4.44 | 95.56 | 9X |
| 5.00 | 95.00 | 10X |

Similarly, other blends of aspartame with different polyol (maltitol, sorbitol, mannitol, erythritol, lactitol, palatinit) were prepared.

### Example 2

General Preparation of Neotame and Polyols:

Approximately 1 gram of sweetener containing neotame or encapsulated neotame and a polyol was prepared. Neotame and xylitol were dry blended and the resulting mixtures had the following composition (as described in Table 3).

TABLE 3

| Neotame (wt/wt %) | Xylitol (wt/wt %) | Sucrose equivalent |
|---|---|---|
| 0.012 | 99.988 | 2X |
| 0.025 | 99.975 | 3X |
| 0.037 | 99.963 | 4X |
| 0.050 | 99.950 | 5X |
| 0.062 | 99.938 | 6X |
| 0.075 | 99.925 | 7X |
| 0.087 | 99.913 | 8X |
| 0.100 | 99.900 | 9X |
| 0.112 | 99.888 | 10X |

Similarly, other blends of aspartame with different polyol (maltitol, sorbitol, mannitol, erythritol, lactitol, palatinit) was prepared.

### Example 3

General Preparation of Aspartame and Polyols:

Approximately 1 gram of sweetener containing sucralose and polyols were prepared. Sucralose and xylitol were dry blended and the resulting mixtures had the following compositions (as described in Table 4).

TABLE 4

| Sucralose (wt/wt %) | Xylitol (wt/wt %) | Sucrose equivalent |
|---|---|---|
| 0.16 | 99.84 | 2X |
| 0.33 | 99.67 | 3X |
| 0.50 | 99.50 | 4X |
| 0.66 | 99.34 | 5X |
| 0.83 | 99.17 | 6X |
| 1.00 | 99.00 | 7X |
| 1.16 | 98.84 | 8X |
| 1.33 | 98.67 | 9X |
| 1.50 | 98.50 | 10X |

Similarly, other blends of sucralose with different polyol (maltitol, sorbitol, mannitol, erythritol, lactitol, palatinit) were prepared.

### Example 4

General Preparation of Acesulfame-K and Polyols.

Approximately 1 gram of sweetener containing acesulfame-K and polyols was prepared. Acesulfame-K and xylitol were dry blended and the resulting mixtures had the following compositions (as described in Table 5).

TABLE 5

| Acesulfame-K (wt/wt %) | Xylitol (wt/wt %) | Sucrose equivalent |
|---|---|---|
| 0.50 | 99.50 | 2X |
| 1.00 | 99.00 | 3X |
| 1.50 | 98.50 | 4X |
| 2.00 | 98.00 | 5X |
| 2.50 | 97.50 | 6X |
| 3.00 | 97.00 | 7X |
| 3.50 | 96.50 | 8X |
| 4.00 | 96.00 | 9X |
| 4.50 | 95.50 | 10X |

Similarly, other blends of acesulfame-K with different polyol (maltitol, sorbitol, mannitol, erythritol, lactitol, palatinit) were prepared.

### Example 5

General Preparation of Saccharin and Polyols.

Approximately 1 gram of sweetener containing saccharin and polyols was prepared. Saccharin and xylitol were dry blended and the resulting mixtures had the following compositions (as described in Table 6).

TABLE 6

| Saccharin (wt/wt %) | Xylitol (wt/wt %) | Sucrose equivalent |
|---|---|---|
| 0.33 | 99.67 | 2X |
| 0.66 | 99.34 | 3X |
| 1.00 | 99.00 | 4X |
| 1.33 | 98.67 | 5X |
| 1.66 | 98.34 | 6X |
| 2.00 | 98.00 | 7X |
| 2.33 | 97.67 | 8X |
| 2.66 | 97.34 | 9X |
| 3.00 | 97.00 | 10X |

Similarly, other blends of saccharin with different polyol (maltitol, sorbitol, mannitol, erythritol, lactitol, palatinit) were prepared.

### Example 6

General Preparation of Cyclamate and Polyols.

Approximately 1 gram of sweetener containing cyclamate and polyols was prepared. Cyclamate and xylitol were dry blended and the resulting mixtures had the following compositions (as described in Table 7).

TABLE 7

| Cyclamate (wt/wt %) | Xylitol (wt/wt %) | Sucrose equivalent |
|---|---|---|
| 3.33 | 96.67 | 2X |
| 6.66 | 93.34 | 3X |
| 10.00 | 90.00 | 4X |
| 13.33 | 86.67 | 5X |

Similarly, other blends of cylamate with a different polyol (maltitol, sorbitol, mannitol, erythritol, lactitol, palatinit) were prepared.

The following examples are directed to evaluations of taste-modifying high-intensity sweetener and polyol blends in either cola-flavored beverage or a reconstituted powder soft drink containing a sweetener-polyol blend equivalent to 10% sucrose.

Evaluation of cola-flavored beverages was conducted using a beverage containing water, sodium benzoate (0.165), phosphoric acid (0.22%), citric acid 90.05%), trisodium citrate (0.08%), caffeine (0.03%), flavor 28 (1.72%), sweetened with high-intensity sweetener-polyol blends (equivalent to 10% sucrose), and adjusted to pH 3.2 using sodium citrate.

### Example 7

Addition of aspartame-xylitol blend to the cola-flavored beverage positively affected the quick onset and no linger.

### Example 8

Addition of neotame-xylitol blend to the cola-flavored beverage positively affected the quick onset and less linger.

### Example 9

Addition of acesulfame-K-xylitol blend to the cola-flavored beverage positively affected the no after taste and linger.

### Example 10

Addition of saccharin-xylitol blend to the cola-flavored beverage positively affected the no metallic or after taste.

Taste evaluations were conducted on sweetened coffee or tea beverages prepared by dissolving the solid tabletop sweetener-polyol blend (total weight of 1 g and equivalent to two sugar spoons) in a cup of brewed coffee or tea. Addition of acesulfame-K-xylitol blend to the cola-flavored beverage positively affected the no after taste and linger.

### Example 11

Addition of aspartame-xylitol blend to the coffee beverage positively affected the quick onset and no linger.

### Example 12

Addition of neotame-xylitol blend to the coffee flavored beverage positively affected the quick onset, less linger and no astringent taste.

### Example 13

Addition of acesulfame-K-xylitol blend to the coffee flavored beverage positively affected the no after taste and linger.

### Example 14

Addition of saccharin-xylitol blend to the tea flavored beverage positively affected the no metallic or after taste.

While the invention has been described with reference to the preferred embodiments, it will be understood by those skilled in the art that various changes in form and detail may be made therein without departing from the spirit and scope of the invention as defined by the appended claims.

1. A sweetener composition, comprising a mixture of:
(a) high-intensity sweetener and
(b) polyol,
wherein said high-intensity sweetener is added in an amount from about 0.0001% to 15% by weight.

2. The sweetener composition of claim 1, wherein the high-intensity sweetener is selected from the group consisting of: aspartame, encapsulated aspartame, neotame, encapsulated neotame, cyclamate, sucralose, saccharin, acesulfame-K, or any combination thereof.

3. The sweetener composition of claim 1, wherein the polyol is selected from the group consisting of: maltitol, sorbitol, mannitol, erythritol, xylitol, lactitol, palatinit, or any combination thereof.

4. The sweetener composition of claim 2, wherein the polyol is selected from the group consisting of: maltitol, sorbitol, mannitol, erythritol, xylitol, lactitol, palatinit, or any combination thereof.

5. The sweetener composition of claim 1, wherein the high-intensity sweetener is in the form of a dry powder.

6. The sweetener composition of claim 1, wherein the high-intensity sweetener is in the form of crystals.

7. The sweetener composition of claim 1, wherein the polyol is in the form of a dry powder.

8. The sweetener composition of claim 1, wherein the polyol is in the form of crystals.

9. The sweetener composition of claim 1, wherein the mixture is blended in the dry form.

10. The sweetener composition of claim 1, wherein the mixture positively affects the taste.

11. The sweetener composition of claim 1, wherein the mixture positively affects the quick onset.

12. The sweetener composition of claim 1, wherein the mixture positively affects the level of sweet linger.

13. The sweetener composition of claim 1, wherein the mixture contains reduced calories.

14. A method for improving the taste of a sweetener composition, comprising the step of combining a high-intensity sweetener and a polyol, wherein said high-intensity sweetener is added in an amount of from about 0.0001% to 15% by weight.

15. The method of claim 14, wherein the high-intensity sweetener is selected from a group consisting of: aspartame, encapsulated aspartame, neotame, encapsulated neotame, cyclamate, sucralose, saccharin, acesulfame-K or any combination thereof.

16. The method of claim 14, wherein the polyol is selected from a group consisting of: maltitol, sorbitol, mannitol, erythritol, xylitol, lactitol, palatinit or any combination thereof.

17. The method of claim 15, wherein the polyol is selected from a group consisting of: maltitol, sorbitol, mannitol, erythritol, xylitol, lactitol, palatinit or any combination thereof.

18. The method of claim 14, wherein the high-intensity sweetener is in the form of a dry powder.

19. The method of claim 14, wherein the high-intensity sweetener is in the form of crystals.

20. The method of claim 14, wherein the polyol is in the form of a dry powder.

21. The method of claim 14, wherein the polyol is in the form of crystals.

22. The method of claim 14, wherein the sweetener composition is blended in the dry form.

23. The method of claim 14, wherein the sweetener composition positively affects the quick onset.

24. The method of claim 14, wherein the sweetener composition positively affects the level of sweet linger.

25. The method of claim 14, wherein the sweetener composition contains reduced calories.

26. The method of claim 14, further comprising the step of adding the composition to a consumable product.
